(19) United States
(12) Patent Application Publication
(10) Pub. No.: US 2007/0300188 A1
(43) Pub. Date: Dec. 27, 2007

(54) Method and apparatus for displaying information about external devices and computer readable recording medium storing program executing the method

(75) Inventor: Hye-rin Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/649,868

(22) Filed: Jan. 5, 2007

(30) Foreign Application Priority Data
Jun. 27, 2006 (KR) 10-2006-0058072

(51) Int. Cl. G06F 3/048

(52) U.S. Cl. 715/835; 715/764; 715/771

(57) ABSTRACT

Provided are a method and apparatus for displaying information about an external device and a computer readable recording medium storing a program executing the method. The display method includes receiving an input signal from the external device; determining an icon to be displayed with reference to information related to the type of the external device, which is included in the input signal; determining an on-screen position at which the icon will be displayed with reference to input terminal information included in the input signal; and displaying the icon at the determined position. Accordingly, a user can be visually and intuitively aware of the connection state of the external device.

### CROSS-REFERENCE TO RELATED PATENT APPLICATION

This application claims priority from Korean Patent Application No. 10-2006-0058072, filed on Jun. 27, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a user interface, and more particularly, to a method and apparatus for displaying information about an external device and a computer readable recording medium storing a program executing the method.

2. Description of the Related Art

Digital television (TV) systems are being used to reproduce data stored in external devices such as camcorders, digital cameras, Personal Music Player's (PMPs) and Digital Video Disc (DVD) players, which are connected to the digital TV system. In order to view or hear the contents of these external devices, a user selects an external input function to display a menu on the digital TV. The menu allows the user to see connection states of the external devices so that the user may choose an active external device of their choice. However, the existing method using a menu is inconvenient for general users of digital TVs who are not accustomed to using detailed functions of the digital TV including functions related to connecting external devices to the digital TV system. Accordingly, a user interface method that allows users to be able to easily and intuitively access information related to the external devices is needed.

### SUMMARY OF THE INVENTION

Exemplary embodiments of the present invention provide a display method and apparatus for allowing users to easily and intuitively access information related to an external device connected to the apparatus and a computer readable recording medium storing a program executing the method.

According to an aspect of the present invention, there is provided a method of displaying information related to external devices connected to a display apparatus, comprising: receiving an input signal from the external device; determining an icon to be displayed on the display apparatus with reference to information about the type of the external device connected to the display apparatus, which is included in the input signal; determining an on-screen position at which the icon will be displayed with reference to input terminal information included in the input signal, wherein the external device is connected to the display apparatus through the input terminal; and displaying the icon at the determined position.

The method may be performed when the external device is connected to the display apparatus, the state of the external device connected to the display apparatus is changed, or the display apparatus is powered on.

The display apparatus may correspond to a digital TV system and the displaying of the icon may comprise displaying the icon on the screen of the digital TV system.

The display apparatus may correspond to a digital TV system and the displaying of the icon may comprise displaying the icon in an On-Screen Display (OSD) window of the digital TV system.

The determining of an icon to be displayed may comprise determining an icon to be displayed with reference to information about the state of the external device, which is included in the input signals. When the state of the external device is changed, the method may further comprise displaying an icon representing the changed state of the external device instead of the currently displayed icon.

The information about the state of the external device may include at least one of a power-off state, a power-on state, a playing state and an interrupted state.

The determining of an icon to be displayed may comprise determining an icon to be displayed with reference to information about the model or further specification of the external device, which is included in the input signal.

The determining of an on-screen position at which the icon will be displayed may comprise determining a predetermined on-screen position corresponding to the position of an input terminal connected, through which the external device is connected to the display apparatus.

The method may further comprise converting a display mode of the display apparatus to a mode of displaying an image input from the external device.

The method may further comprise, removing the displayed icon from the screen after a predetermined period of time if the displayed icon is not selected, and displaying the removed icon on the screen again when a menu for selecting external devices is selected.

The method may further comprise displaying an icon representing a connection terminal of the display apparatus that is not connected to any external device, at an on-screen position corresponding to the connection terminal.

According to another aspect of the present invention, there is provided an apparatus for displaying information related to an external device, comprising: a display unit; an input signal receiver which receives an input signal including information related to the type of the external device and information related to an input terminal connected to the external device; a storage unit including a database which stores icon information for displaying the information about the external device; and a controller which receives the input signal from the input signal receiver, searching the database for an icon representing the type of the external device based on the input signal, determining a position at which the searched icon will be displayed, and controlling the display unit to display the searched icon at the determined position.

The database may include icon information respectively representing the type, model and state of at least one external device that can be connected to the apparatus.

### BRIEF DESCRIPTION OF THE DRAWINGS

The above and other aspects, features, and advantages of the present invention will become more apparent by describing in detail exemplary embodiments thereof with reference to the attached drawings in which:

FIG. 1 is a block diagram of an apparatus for displaying information about an external device according to an exemplary embodiment of the present invention;

FIG. 2 is a flow chart of a method for displaying information about an external device according to an exemplary embodiment of the present invention;

FIG. 3 is a flow chart of a method for displaying information about an external device according to another exemplary embodiment of the present invention;

FIG. 4 illustrates information about external devices displayed on a screen, according to an exemplary embodiment of the present invention;

FIG. 5A illustrates an arrangement of input terminals on the backside of a display apparatus according to an exemplary embodiment of the present invention;

FIG. 5B illustrates information about external devices displayed on the screen of the display apparatus of FIG. 5A, according to an exemplary embodiment of the present invention;

FIG. 6A illustrates an arrangement of input terminals on the backside of a display apparatus according to another exemplary embodiment of the present invention;

FIG. 6B illustrates information about external devices displayed on the screen of the display apparatus of FIG. 6A, according to another exemplary embodiment of the present invention;

FIG. 7A illustrates an arrangement of input terminals on the backside of a display apparatus according to another exemplary embodiment of the present invention; and

FIG. 7B illustrates information about external devices displayed on the screen of the display apparatus of FIG. 7A, according to another exemplary embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the exemplary embodiments set forth herein; rather, these embodiments are provided so that this disclosure will be thorough and complete, and will fully convey the concept of the invention to those skilled in the art. Throughout the drawings, like reference numerals refer to like elements.

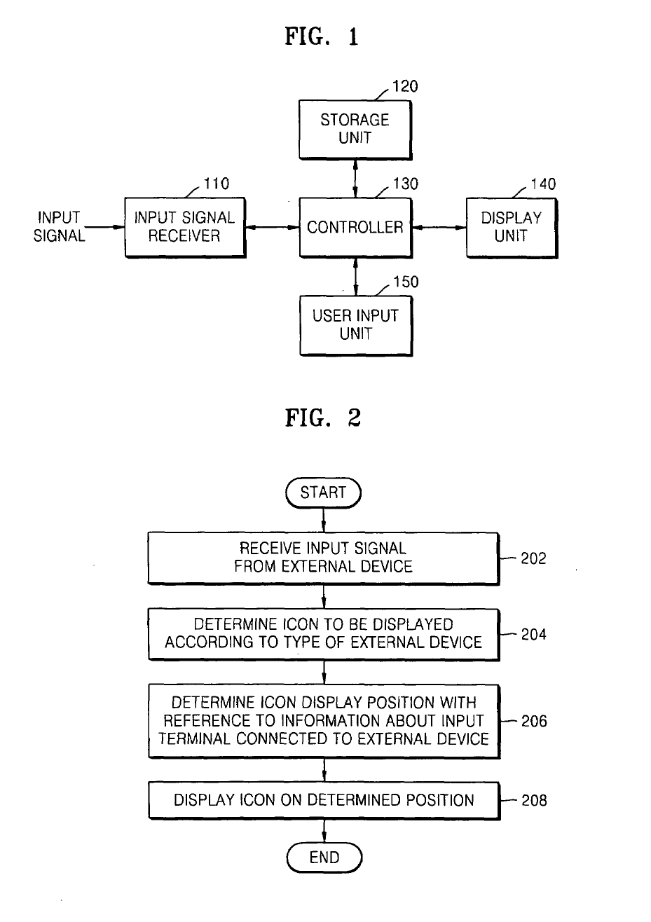

FIG. 1 is a block diagram of an apparatus for displaying information related to an external device according to an exemplary embodiment of the present invention. The apparatus includes a display unit 140, an input signal receiver 110, a storage unit 120, and a controller 130. While the apparatus can be a digital TV system, it is not limited thereto and it can be applied to any computing system including a display and providing a function of receiving inputs from external devices.

The display unit 140, which may be a monitor, displays contents of selected channels on a screen. Information related to external devices is displayed on the screen of the display unit 140. The information related to an external device can be displayed at an OSD window. The displayed information may be a graphic icon representing the type of the external device. However, the displayed information is not limited to the graphic icon and it may be data in other formats including text data. Furthermore, the displayed information can be a graphic icon representing the model or the current state of the external device. Moreover, the graphic icon may represent whether the external device is connected to an input terminal disposed in a position corresponding to the graphic icon on the screen of the display unit 140. That is, when there is an input terminal to which no external devices are connected, an icon representing that no external devices are connected to the input terminal may be displayed on the screen of the display unit 140 at a position corresponding to the input terminal. In the case where an input terminal is connected to an external device, an icon representing that the external device is connected to the input terminal may be displayed at a predetermined position. The displayed information represents a kind of virtual device and a user can control the external device or reproduce contents of the external device through the virtual device.

The apparatus includes at least one input terminal (not shown). When an external device is connected to the input terminal, the input signal receiver 110 receives an input signal from the external device and transmits the received signal to the controller 130. The input signal includes information about the type of the external device and information about the input terminal through which the external device is connected to the display unit 140. Furthermore, the input signal may include information about the model or state of the external device. The controller 130 can analyze the input signal to obtain information related to the type of the external device connected to the input terminal and which input terminal is connected to the external device.

The storage unit 120 includes a database for storing icons used to display information about the external device. The database stores icons representing types of external devices that can be connected to the apparatus. Furthermore, the database can store icons representing the states or models of the external devices that can be connected to the apparatus. Moreover, different models of a particular type of external device may be represented by different icons. For example, when the apparatus supports 10 different models of camcorders, the database can store a total of 20 graphic icons including 10 graphic icons representing power-on states of the respective models and 10 graphic icons representing power-off states of the respective models.

The controller 130 processes data received from the input signal receiver 110, the storage unit 120 and the user input unit 150 and displays the processing result on the display unit 140. The controller 130 receives the input signal from the input signal receiver 110 and determines an icon to be displayed on the display unit 140 and a display position of the icon according to the information included in the input signal.

To obtain information to be displayed, the controller 130 searches the database of the storage unit 120 for an icon corresponding to the type of the external device included in the input signal. The controller 130 can determine the icon to be displayed by searching the database for an icon corresponding to the model and/or current state of the external device. For example, an external device that is powered on or being played can be represented by an animation icon and an external device that is powered off or interrupted can be represented by a still-image icon. The icon display position is determined with reference to the information about the input terminal. Here, an on-screen position corresponding to the actual input terminal position can be determined as the icon display position to allow the user to intuitively know which input terminal is connected to which external device.

The controller 130 displays information about the external device using the determined icon through the aforementioned method when the external device is connected to the apparatus. The controller 130 can display an icon related to the external device that informs the user that the external device is powered off and powered on. Furthermore, when the state of the external device is changed (for example, when the external device is powered on or off and the external device is being played or interrupted) or the apparatus is powered on, the controller 130 can display an icon representing the type, model and state of the external device connected to the apparatus.

The user input unit 150 transmits a user's input to the controller 130 through a user input device such as a remote controller. When the user selects the currently displayed icon through the user input unit 150, the controller 130 converts a display mode of the apparatus to a mode of displaying an image input from the external device or executes a related application. For example, when the user selects a camcorder icon, the apparatus is converted to an external input mode for displaying an image input from the camcorder to reproduce contents of the camcorder. In order to increase user convenience, the controller 130 removes the displayed icon from the screen when the user does not select the displayed icon related to the external device for a predetermined period of time. The removed icon is displayed again when the user selects a menu in the display unit 140 for selecting an external device. Otherwise, the icon may appear and disappear repeatedly at a predetermined interval.

FIG. 2 is a flow chart of a method of displaying information about an external device according to an exemplary embodiment of the present invention. Referring to FIG. 2, the controller 130 receives an input signal from the external device when the external device is connected to the apparatus, the state of the external device changes or the apparatus is powered on in step 202. In step 204, the controller 130 determines an icon to be displayed according to the type of the external device, which is included in the received input signal from the input signal receiver 110. As described above, the controller 130 can display different icons according to the model and state of the external device. In step 206, the controller 130 determines an icon display position by determining an on-screen position corresponding to an input terminal to which the external device is connected. Then, the controller 130 displays the icon in the determined position in step 208.

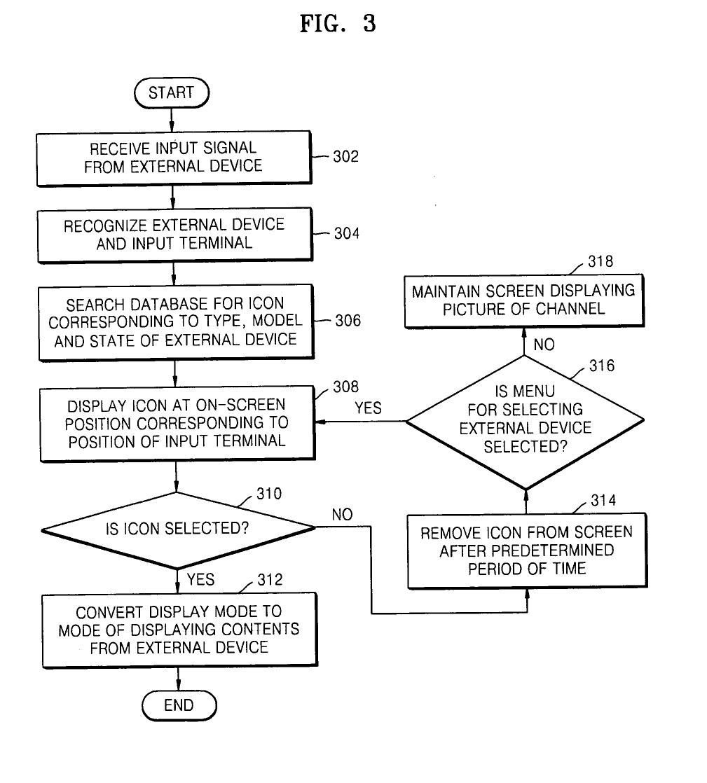

FIG. 3 is a flow chart of a method of displaying information about an external device according to another exemplary embodiment of the present invention. Referring to FIG. 3, the controller 130 receives an input signal from an external device connected to the apparatus in step 302. The controller 130 can ascertain the type, model and state of the external device, which are required to display information about the external device, by recognizing the external device and an input terminal to which the external device is connected with reference to the received input signal in step 304. The controller 130 searches the database storing icon information for graphic information corresponding to the type, model and/or state of the external device in step 306. The controller 130 displays the graphic information, that is, an icon, in a position on the screen which corresponds to the position of the input terminal connected to the external device in step 308. When a user selects the icon in step 310, the display mode of the apparatus is converted to a mode for displaying contents from the external device corresponding to the selected icon in step 312. When the icon is not selected in step 310, the displayed icon is removed from the screen after a predetermined period of time in step 314. When a user selects an external device menu, that is, an external input function in step 316, the controller returns to step 308 to display an icon corresponding to an external device connected to the apparatus. Otherwise, the currently displayed contents are maintained in step 318.

FIG. 4 illustrates information about external devices displayed on a screen, according to an exemplary embodiment of the present invention. Referring to FIG. 4, an icon 411 corresponding to a digital camera 401 and an icon 412 corresponding to a DVD player 402 are displayed on the screen of a digital TV system. As illustrated in FIG. 4, the digital camera 401 is connected to a connection terminal placed at the bottom and to the left of the digital TV system and the DVD player 402 is connected to a connection terminal disposed at the bottom and to the right of the digital TV system. The icon 411 corresponding to the digital camera 401 is displayed at the bottom left of the screen and the icon 412 corresponding to the DVD player 402 is displayed at the bottom right of the screen.

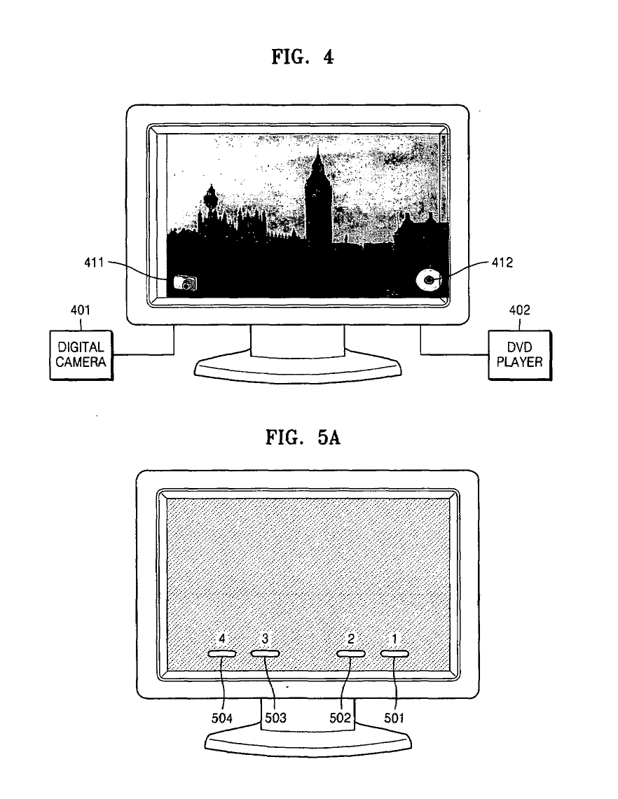

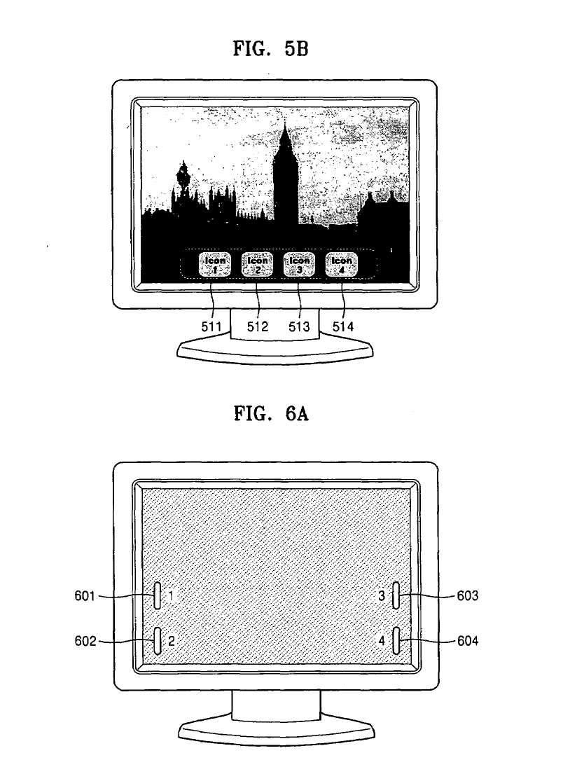

FIG. 5A illustrates an arrangement of input terminals on the back side of a display apparatus according to an exemplary embodiment of the present invention. Referring to FIG. 5A, four input terminals 501, 502, 503 and 504 are arranged at the bottom of the back side of the display apparatus.

FIG. 5B illustrates information about external devices displayed on the screen of the display apparatus of FIG. 5A, according to an exemplary embodiment of the present invention. Referring to FIG. 5B, icons 1, 2, 3 and 4 (511, 512, 513 and 514, respectively) are displayed in positions corresponding to the input terminals 501, 502, 503 and 504 of the display apparatus, respectively. The icons 1, 2, 3 and 4 can be graphic data or text data representing the types, models and states of the external devices.

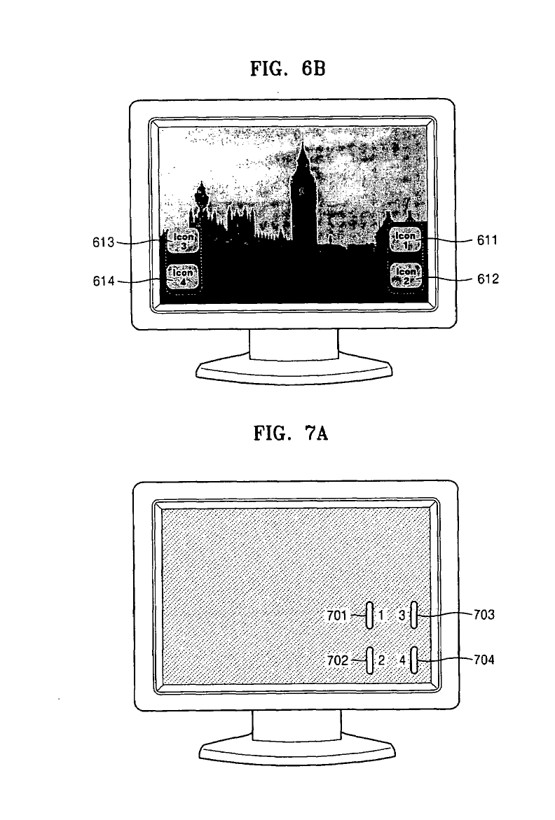

FIG. 6A illustrates an arrangement of input terminals on the back side of a display apparatus according to another exemplary embodiment of the present invention. Referring to FIG. 6A, two input terminals 601 and 602 are arranged at the left of the back side of the display apparatus and other two input terminals 603 and 604 are arranged at the right of the back side of the display apparatus.

FIG. 6B illustrates information about external devices displayed on the screen of the display apparatus of FIG. 6A, according to another exemplary embodiment of the present invention. Referring to FIG. 6B, icons 1, 2, 3 and 4 (611, 612, 613 and 614, respectively) are displayed on positions corresponding to the input terminals 601, 602, 603 and 604 of the display apparatus, respectively.

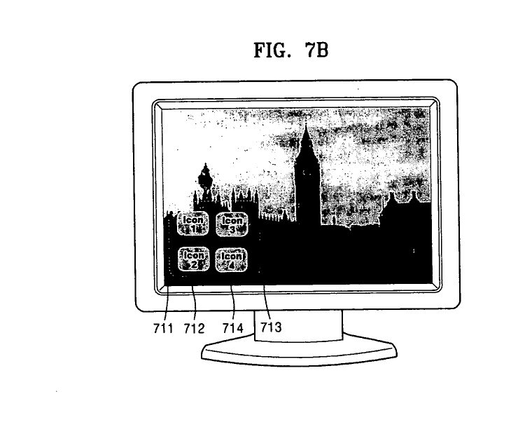

FIG. 7A illustrates an arrangement of input terminals on the back side of a display apparatus according to another exemplary embodiment of the present invention. Referring to FIG. 7A, four input terminals 701, 702, 703 and 704 are arranged at the right of the back side of the display apparatus.

FIG. 7B illustrates information about external devices displayed on the screen of the display apparatus of FIG. 7A, according to another exemplary embodiment of the present invention. Referring to FIG. 7B, icons 1, 2, 3 and 4 (711, 712, 713 and 714, respectively) are displayed at positions corresponding to the input terminals 701, 702, 703 and 704 of the display apparatus, respectively.

The method of displaying information about an external device according to an aspect of the present invention can be embodied as computer readable codes on a computer readable recording medium.

According to an aspect of the present invention, a user may be better visually and intuitively aware of the connection state of an external device so that the user can use the external device more conveniently.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of displaying information on a display apparatus, comprising:
receiving an input signal from an external device;
determining an icon to be displayed with reference to information related to a type of the external device, which is included in the input signal;
determining an on-screen position at which the icon will be displayed with reference to input terminal information included in the input signal; and
displaying the icon at the determined position.

2. The method of claim 1, wherein the method is performed when the external device is connected to the display apparatus, the state of the external device connected to the display apparatus is changed, or the display apparatus is powered on.

3. The method of claim 1, wherein the display apparatus corresponds to a digital TV system and the displaying of the icon comprises displaying the icon on the screen of the digital TV system.

4. The method of claim 1, wherein the display apparatus corresponds to a digital TV system and the displaying of the icon comprises displaying the icon in an on-screen display window of the digital TV system.

5. The method of claim 1, wherein the determining of an icon to be displayed comprises determining an icon to be displayed with reference to information about the state of the external device, which is included in the input signal, and the method further comprises, when the state of the external device is changed, displaying an icon representing the changed state of the external device replacing the currently displayed icon representing a previous connection state of the external device.

6. The method of claim 5, wherein the information about the state of the external device includes at least one of a power-off state, a power-on state, a playing state and an interrupted state.

7. The method of claim 1, wherein the determining of an icon to be displayed comprises determining an icon to be displayed with reference to information about the model of the external device, which is included in the input signal.

8. The method of claim 1, wherein the determining of an on-screen position at which the icon will be displayed comprises determining an on-screen position corresponding to the position of the input terminal based on the input terminal information, wherein the external device is connected to the input terminal.

9. The method of claim 1, wherein the determining of an on-screen position at which the icon will be displayed comprises determining an on-screen position corresponding to an actual position of an input terminal based on the input terminal information, wherein the external device is connected to the input terminal, so that a user can be intuitively aware of which input terminal is connected to the external device.

10. The method of claim 1, further comprising converting a display mode of the display apparatus to a mode of displaying contents from the external device.

11. The method of claim 10, further comprising:
when the displayed icon is not selected, removing the displayed icon from the screen after a predetermined period of time; and
displaying the removed icon on the screen again when a menu for selecting the external device is selected.

12. The method of claim 1, further comprising displaying an icon representing a connection terminal of the display apparatus, which is not connected to any external device, at an on-screen position corresponding to the connection terminal.

13. An apparatus for displaying information related to an external device, comprising:
a receiver which receives an input signal from the external device, wherein the input signal comprises information related to a type of the external device and information related to an input terminal;
a storage unit comprising a database which stores icon information for displaying the information related to the external device; and
a controller which receives the input signal from the input signal receiver, searches the database for an icon representing the type of the external device, determines a position at which the searched icon will be displayed, and controls a display unit to display the searched icon at the determined position.

14. The apparatus of claim 13, wherein the controller controls the display unit to display the searched icon corresponding to the external device when the external device is connected to the apparatus, a state of the external device connected to the apparatus is changed, or the apparatus is powered on.

15. The apparatus of claim 13, wherein the apparatus is a digital TV system, and the controller displays the searched icon on the screen of the digital TV system.

16. The apparatus of claim 13, wherein the apparatus is a digital TV system, and the controller displays the searched icon on an on-screen display window of the digital TV system.

17. The apparatus of claim 13, wherein the controller determines the icon to be displayed by searching the database for an icon with reference to information related to a state of the external device, which is included in the input signal, when the state of the external device changes and the controller displays an icon representing the changed state of the external device replacing the currently displayed icon representing a previous connection state of the external device.

18. The apparatus of claim 17, wherein the information about the state of the external device includes at least one of a power-off state, a power-on state, a playing state and an interrupted state.

19. The apparatus of claim 13, wherein the controller searches the database for the icon to be displayed with reference to information related to a model of the external device, which is included in the input signal.

20. The apparatus of claim 13, wherein the controller determines the icon display position by determining an on-screen position corresponding to the position of the input terminal based on the input terminal information, wherein the external device is connected to the input terminal.

21. The apparatus of claim 13, wherein the controller determines the icon display position by determining an on-screen position corresponding to an actual position of the input terminal based on the input terminal information, wherein the external device is connected to the input terminal, so that a user can be intuitively aware of which input terminal is connected to the external device.

22. The apparatus of claim 13, further comprising a user input unit, wherein the controller converts a display mode of the apparatus to a mode of displaying contents from the external device when the displayed icon is selected through the user input unit.

23. The apparatus of claim 22, wherein, when the display icon is not selected, the controller removes the displayed icon from the screen after a predetermined period of time and displays the removed icon again when a menu for selecting the external device is selected.

24. The apparatus of claim 13, wherein the database includes icon information representing a type, model and state of at least one external device for which the apparatus is configured to be connected.

25. The apparatus of claim 13, wherein the controller displays an icon representing a connection terminal of the apparatus that is not connected to any external device, at an on-screen position corresponding to the connection terminal.

26. A computer readable recording medium storing a program implementing functions of displaying information related to an external device connected to a digital TV system, said functions comprising:
receiving an input signal from the external device;
determining an icon to be displayed with reference to information related to a type of the external device, which is included in the input signal;
determining an on-screen position at which the icon will be displayed with reference to input terminal information included in the input signal; and
displaying the icon at the determined position on the screen of the digital TV system.
